(19) United States
(12) Patent Application Publication
(10) Pub. No.: US 2017/0303370 A1
(43) Pub. Date: Oct. 19, 2017

(54) LIGHTING SYSTEM AND METHOD FOR GENERATING LIGHTING SCENES

(71) Applicant: PHILIPS LIGHTING HOLDING B.V., EINDHOVEN (NL)

(72) Inventor: FETZE PIJLMAN, EINDHOVEN (NL)

(21) Appl. No.: 15/516,214

(22) PCT Filed: Sep. 21, 2015
(86) PCT No.: PCT/EP2015/071526

§ 371 Date: Mar. 31, 2017

(30) Foreign Application Priority Data
Oct. 2, 2014 (EP) 14187483.4

(51) Int. Cl. H05B 37/02

(52) U.S. Cl. CPC H05B 37/029; H05B 37/0245

(57) ABSTRACT

Methods and systems for generating and controlling a lighting scene of an environment (100) are described. The environment (100) has one or more controllable lighting devices (140, 150, 160, 170, 180, 190). A keyword for a desired lighting scene for the environment is received, such as “nature”, and one or more images of the environment are provided in which at least one of the one or more lighting devices is controlled to provide an effect on the environment. An image source is explored, based on the keyword and images retrieved. The provided images are compared with the retrieved images to generate one or more lighting scenes and associated parameters of the one or more lighting devices, and the keyword associated with the one or more lighting scenes. The comparison may comprise one or more of color contrast, hue matching, pattern recognition to derive the lighting scenes and associated parameters to reproduce the lighting scene in the environment (100) upon recall of the keyword.

### FIELD OF THE INVENTION

The invention relates to a method, system and computer program product for controlling a lighting scene of an environment.

### BACKGROUND OF THE INVENTION

Intelligent lighting is a growing field, with many customizable options. An environment may have several luminaires installed, each individually controllable to produce indirect, narrow spot, broad or diffuse effects, and possibly of different hues. The overall effect is often called a light or lighting scene or profile, and can alter the atmosphere or “mood” of the room.

### SUMMARY OF THE INVENTION

A particular problem lies in the complexity of the interaction of the illumination from the lighting devices installed or placed in the environment, which may interact in an unpredictable manner when one considers the furnishing and fittings, and decoration and general layout of the particular room or environment. Setting a desired lighting atmosphere or scene that makes sense to the user in such diverse environments is challenging, due to the large number of potential variables.

There is therefore a desire to provide a solution to the above challenges.

According to a first aspect, there is provided a method for generating one or more lighting scenes of an environment having at least one or more controllable lighting devices, comprising receiving a keyword for a desired lighting scene for the environment, providing one or more images of the environment in which at least one of the one or more lighting devices is controlled to provide an effect on the environment, retrieving one or more images from an image source based on the keyword, determining one or more lighting scenes for the environment by comparing the provided images with the retrieved images to generate one or more lighting scenes and associated parameters of the one or more lighting devices, and associating the generated one or more lighting scenes and parameters with the keyword.

Preferably, a method for generating one or more lighting scenes of an environment having a plurality of controllable lighting devices, comprises steps of: receiving a keyword for a desired lighting scene for the environment, providing a plurality of images of the environment, in each of which at least one of the plurality of lighting devices is controlled to provide different effects on the environment, retrieving one or more images from an image source based on the keyword, and determining one or more lighting scenes for the environment by comparing the retrieved images with a combination of the provided images to generate one or more lighting scenes and associated parameters of the plurality of lighting devices, and associating the generated one or more lighting scenes and parameters with the keyword. For instance, in each of said plurality of provided images the different effect comprises a different one of the plurality of lighting devices being controlled to be switched on while the others of the plurality of lighting devices are switched off.

The keyword may be input or selected by for instance a user after the images of the environment are provided.

In an embodiment, the determination of the one or more lighting scenes may comprise comparing or correlating color values between the provided images of the environment and the retrieved one or more images or in addition or alternatively correlating color contrasts between the provided scene images of the environment and the retrieved set of images.

In an embodiment, the determination of the one or more lighting scenes may comprise applying pattern recognition to the provided one or more images.

In another embodiment, the one or more lighting scenes may comprise a dynamic lighting scene.

In an embodiment, the provided one or more images may be generated by controlling the one or more lighting devices in sequence. For example, the one or more lighting devices may be cycled through their respective capabilities to provide the one or more images. Hence color controllable lighting devices (such as RGB lighting devices for example) may be controlled to provide different effects on the environment via color, hue, brightness or dimming effects.

In an embodiment, the one or more lighting scenes may be generated in a linear fashion based on the cycling. For example, linear combinations of images in which the dimming parameters are varied, and/or the RGB values may be varied may be computed to derive one or more lighting scenes, or a set of lighting scenes for association with one or more keywords.

In an embodiment, the identification of the one or more lighting devices is used in addition to the provided images to derive settings or parameters to reproduce the generated lighting scene.

In an embodiment a background or ambient image of the environment may be provided in which none of the lighting devices are illuminated.

The provided one or more images may be generated by for example a user from a fixed position with respect to the environment in another embodiment. Optionally, the provided one or more images may be generated automatically such that a camera in a fixed position is synced with the lighting control system so a picture or image is taken of the environment as the lighting devices are controlled so that each individual lighting device is activated with the remaining devices de-activated in turn, so that one image per active device is provided.

In another embodiment, lighting devices having various settings may be cycled through at least some of those settings to provide a sequence of images of the environment.

In an embodiment, the image source may be a public database of photos or images such as Flickr™ or other such publicly accessible image databases. Alternatively, or in addition, a database of the user may be utilized, such as a user's holiday album or other such personal photographs.

The provided images of the environment may comprise a user generated movie or sequence of images in yet another embodiment.

Advantageously, in an embodiment the determined lighting scene is associated with the keyword for easy recall and control of the lighting scene of the environment by the user. Hence an environment with a general green/yellow hue may be associated with the keyword “nature”, although the keyword can be any one of the users choosing, and may have personal recollections or attachment to the user.

The system 300 may store such feedback and offer alternative computed lighting scenes that have a similar correlation in for example pattern, color. Learning algorithms may be implemented by the system to improve keyword to lighting scene association.

According to a second aspect, there is provided a computer program product comprising computer executable code for performing the steps of the method. The computer program may be implemented on any computing device such as personal computer or laptop, tablet, camera or on a server in communication with such a computing device via a network interface.

According to a third aspect, there is provided a system for generating a lighting scene of an environment, the system being arranged to perform the steps of the method aspects, by for instance executing the computer program product of the second aspect. The system comprises an input interface for receiving a keyword for a desired lighting scene for the environment, and for receiving one or more provided images of the environment in which at least one of the one or more lighting devices is controlled to provide an effect on the environment, and an interface for communication with at least one processor, wherein the processor is arranged to retrieve one or more images from an image source based on the keyword, determine one or more lighting scenes for the environment by comparing the provided images with the retrieved images to generate one or more lighting scenes and associated parameters of the one or more lighting devices, and associate the generated one or more lighting scenes and parameters with the keyword.

Preferably, a system for generating a lighting scene of an environment comprises: an input interface for receiving a keyword for a desired lighting scene for the environment, and for receiving a plurality of provided images of the environment in each of which a plurality of lighting devices are controlled to provide different effects on the environment, and an interface for communication with at least one processor, wherein the processor is arranged to: retrieve one or more images from an image source based on the keyword, determine one or more lighting scenes for the environment by comparing the retrieved images with a combination of the provided images to generate one or more lighting scenes and associated parameters of the plurality of lighting devices, and associate the generated one or more lighting scenes and parameters with the keyword.

In an embodiment, the interface includes a network interface for communication with a server and the image source.

The generation of the one or more lighting scene may be performed by a server in communication with the user computing device in an embodiment.

In an embodiment, the computed lighting scene and associated parameters or settings for the lighting devices may be offered to the user for approval in the environment, and associated with the keyword or disregarded by the processor in dependence on that approval.

In an embodiment the system may store such feedback and offer alternative computed lighting scenes that have a similar correlation in for example pattern, color.

In an embodiment learning algorithms may be implemented improve keyword to lighting scene association in dependence on user feedback.

Other aspects and features are described with reference to the appended claims.

### BRIEF DESCRIPTION OF DRAWINGS

To understand some embodiments, reference will now be made by way of example only to the accompanying drawings, in which:

FIG. 1 shows an example environment;

FIG. 2 illustrates an environment with active lighting devices creating a lighting scene or atmosphere;

FIG. 3 illustrates a system according to an embodiment;

FIG. 4 shows an exemplary method according to an embodiment;

FIG. 5 illustrates steps by which a set of images of the environment are provided according to an embodiment; and

FIG. 6 shows steps in a method for computing lighting scenes according to an embodiment.

### DETAILED DESCRIPTION OF EMBODIMENTS

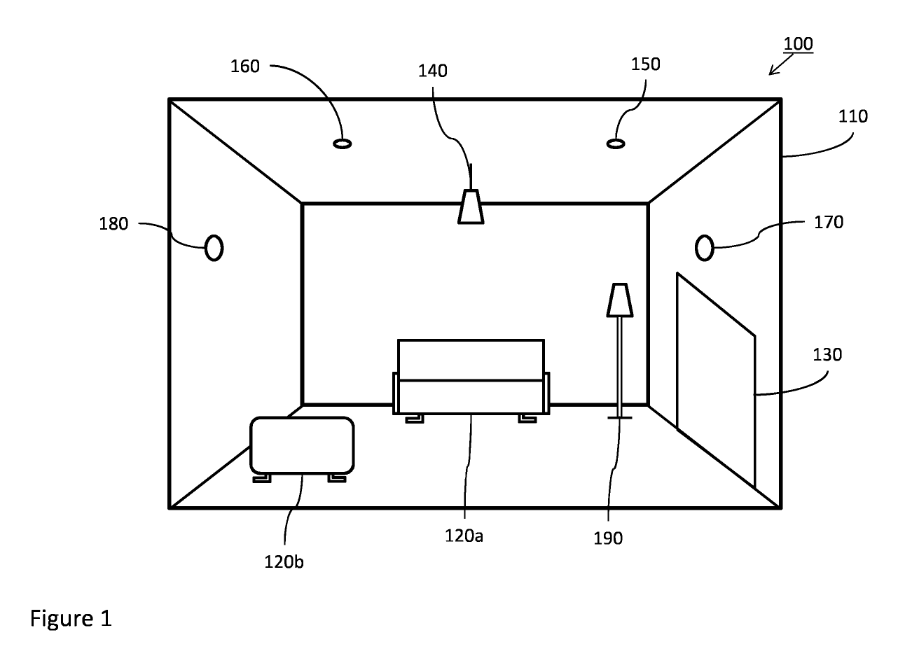

FIG. 1 shows an example illustration of an environment 100 such as living room or lounge of a user, although it should be noted that embodiments of the invention are applicable in other environments such as bedrooms, kitchens, bath or shower rooms or other larger scale infrastructures such as retail outlets, shopping malls or restaurants for example.

The environment 100, by way of example comprises fittings and fixtures such as furniture couch 120a and a television 120b, which is shown on the floor of the environment in the Figure, but could of course alternatively be wall mounted. The environment 100 may also comprise a fitting 130 in the form of a doorway, or a bookcase or a painting or mirror for example.

The environment comprises several lighting devices 140, 150, 160, 170, 180. The lighting devices as shown may be in the form of a ceiling mounted pendant luminaire 140, ceiling recessed spot lights 150, 160 and wall mounted lights 170, 180. The environment may also be provided with a hanging lamp 190 as shown.

Each lighting device 140, 150, 160, 170, 180, 190 may be switched on or off as usual, and one or more of the lighting devices may be “intelligent” or programmable in that they offer different luminance (dimming), and may also provide a range of hues (warm white to cold white) or colors to provide a lighting atmosphere or light scene.

It will be appreciated that FIG. 1 is by way of example in order to aid understanding and provide context, and that embodiments are applicable across many different environments having a plurality of lighting devices.

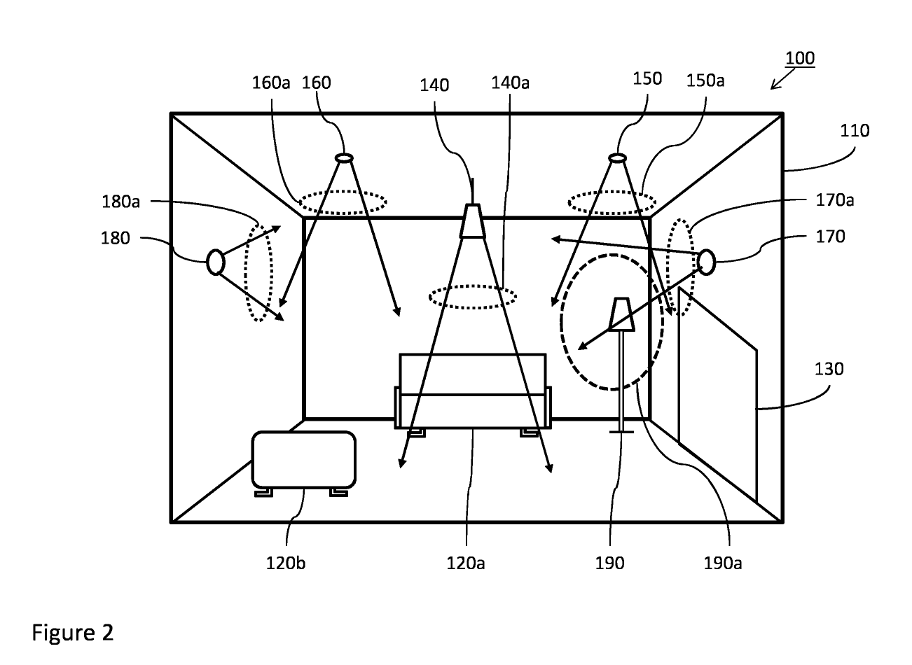

FIG. 2 illustrates the environment 100 with the lighting devices 140, 150, 160, 170, 180, 190 activated. Lighting device 140 is shown having a light cone of influence 140a. Lighting devices 150, 160, 170, 180 are shown having respective light cones of influence 150a, 160a, 170a, 180a, and lighting device 190 is shown having a broad diffuse lighting cone or sphere 190a.

The applicant has realized that the complexity of the interaction of the illumination from the lighting devices in the environment, which interact in an unpredictable manner when one considers the furnishing and fittings, reflectivity, ambient light and/or decoration and general layout of the particular room or environment leads to a huge potential universe of variables to create a customized light scene for that particular environment. Setting a desired lighting atmosphere or scene that makes sense to the user is therefore challenging, due to the large number of potential variables.

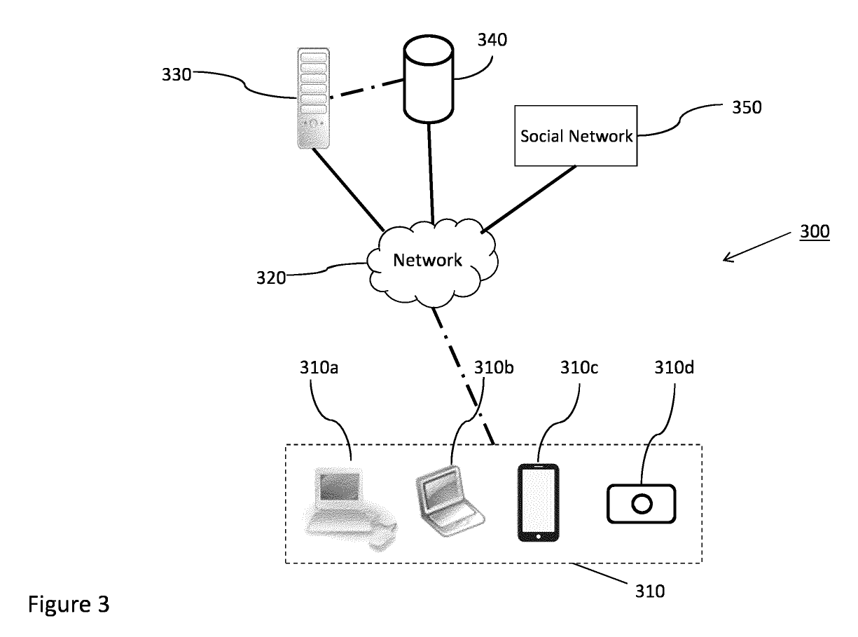

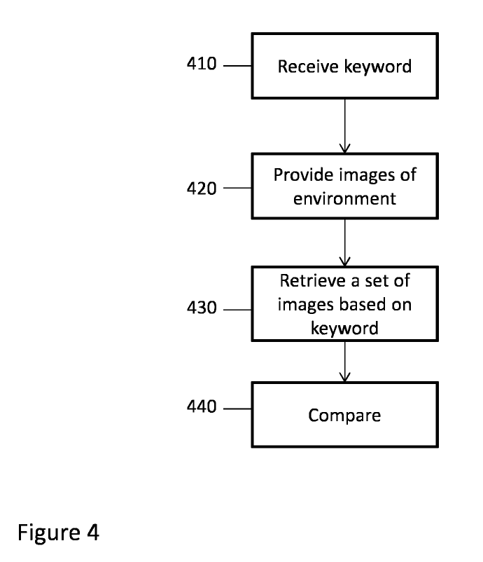

Embodiments to create a customized light scene, in a user friendly manner will now be described with reference to FIGS. 3 and 4, which illustrate an embodiment of a system and an embodiment of an exemplary method respectively.

FIG. 3 shows an embodiment of a system 300 in which various user devices 310 may connect via a network 320 to a server or other computing device 330. The user devices 300 may be in the form of a personal computer 310a, a laptop 310b, a smart phone 310c or a network enabled camera 310d.

The system in some embodiments may include an intelligent home lighting system (not shown) controllable from a user device 310.

The system also comprises an image store or database of images 340 which in some embodiments may comprise a public image database such as Flickr™, accessible via the network 320.

In another embodiment, the image store or database 340 may comprise personal or private images of a user, such as holiday photographs and the like. The image store may be accessible via the network 320 in for instance cloud or server based storage.

Alternatively or in addition the image store may be provided within a social network 350 that the user has access to, and/or within the home network of the system 300, such as for example stored on the personal computer 310a of user.

FIG. 4 illustrates steps in a method embodiment performed by a computing device 310, 330. The process may be embodied in software, or hardware, or a combination thereof.

A keyword is received by the computing device at step 410. For example, the user may input a keyword via an interface of the device 310, which may be via a keyboard, or via a touch or other haptic interface of device 310, or the keyword may be input as a spoken word or phrase and received by a microphone of the device 310 and processed via speech recognition.

The user then proceeds to provide images of the environment 100 to the computing device at step 420. The images may be uploaded to the computing device 310, 330 if for example provided by a camera 310d, although it is of course recognized that user devices 310 are often provided with cameras, particularly in the case of smartphones or tablets 310c.

At step 430 a database of images is explored to retrieve a set of images based on the keyword. For example, a keyword “beach” or “nature” provides a context for the desired lighting scene or atmosphere of the environment 100, and images tagged as such in for example public or private database 340 are retrieved.

At step 440, computing device performs a generating algorithm to generate a desired light scene for the environment 100 based on the keyword, as will be discussed later.

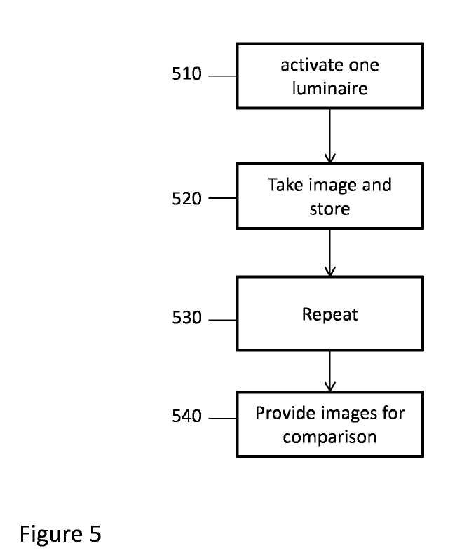

To aid understanding, and by way of example only, FIG. 5 illustrates an example method to provide the images 420.

The images may be uploaded to the computing device 310, if for example provided by a camera 310d, although it is of course recognized that user devices 310 are often provided with internal cameras, particularly in the case of smartphones or tablets 310c.

The provided images in this embodiment comprise a sequence of images in which each lighting device 140, 150, 160, 170, 180, 190 is activated whilst the remaining lighting devices are de-activated to provide an effect on the environment.

Hence, in the environment 100 of FIGS. 1 and 2, six images would be taken. For example, the user controls one lighting device 140 (step 510), with the other lighting devices 150, 160, 170, 180, 190 switched off. A photograph providing an image of the environment with lighting device 140 illuminating an area of the environment is then taken and stored at step 520. This process is then repeated for each lighting device in turn at step 530. For example, the lighting device 150 is subsequently controlled, and lighting devices 140, 160, 170, 180, 190 are switched off and so on, producing a set of provided images of the environment, each image having one lighting device activated. These images are then provided for matching at step 540, by for example uploading these to computing device 310, 330.

In an embodiment, the effect of each lighting device 140, 150, 160, 170, 180, 190 at different settings, for example at different powers (for a dimmable lighting device) or hues (for a color varying device capable of different RGB settings) may be estimated for different parameters or settings based on the images.

For example, lighting scenes may be computed based on an estimated linear response of the lighting device. Alternatively, or in addition, in another embodiment an identification of the lighting device 140, 150, 160, 170, 180, 190 may be provided and the response determined from the specification thereof.

In another embodiment, the images may be provided in the form of a film or short movie of the environment with the lighting devices controlled in turn. This may be advantageous where the lighting devices are controllable in hue or color, so that a lighting device may be cycled through its available characteristics to provide images.

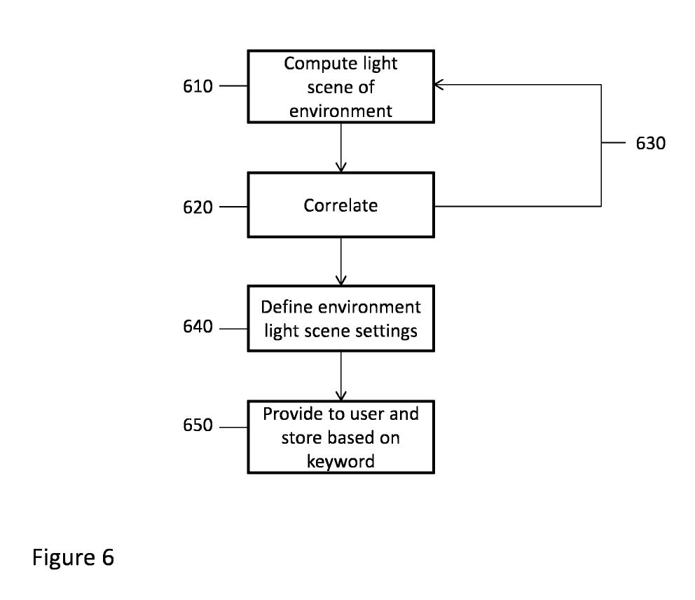

FIG. 6 illustrates an embodiment illustrating the generation of the one or more light scenes for the environment.

At step 610 a light scene of the environment is computed. This may be executed on server 330 in one embodiment, or on user device 310 in an alternative embodiment.

In another embodiment, the task of generating one or more light scenes may be executed by both the server and user device in a server/client environment, or the task may be split across multiple servers or server shards as known to those skilled in the art.

In an embodiment this comprises generating a light scene by taking the provided set of images 420 and adapting the images in color and/or brightness to provide a composite image of the environment.

Subsequently, the computed light scene is correlated at step 620 with the retrieved set of images, or one of those retrieved images. For example, the computing device 310, 330 may correlate color values between the provided images of the environment and the retrieved set of one or images to approach an average value.

In another embodiment, the generation of the lighting scene may also comprise correlating color contrasts between the provided scene images of the environment and the retrieved set of images.

Pattern recognition may be used to identify shapes or borders, (for example a beach/sky horizon), to disregard text in the retrieved images and such like to further refine the correlation.

The light scene may then be iteratively processed as indicated by path 630 until a correlation reaching a desired threshold is reached. This may be subjective in that the scene is displayed to the user for approval, or may be automatic or a mixture of both.

Settings for control of the lighting devices 140, 150, 160, 170, 180, 190, or control of those lighting devices that are programmable are then defined by for example looking up the model and appropriate settings in a database defining the lighting fixture operating characteristics such as brightness, hue and the like at step 640.

The lighting scene may then be associated with the keyword and provided to the environment and stored at step 650.

In an embodiment, the computed lighting scene and associated parameters or settings for the lighting devices may be offered to the user for approval in the environment 100, and associated with the keyword or disregarded by processor 310, 330 in dependence on that approval.

The system 300 may store such feedback and offer alternative computed lighting scenes that have a similar correlation in for example pattern, color. Learning algorithms may be implemented by the system to improve keyword to lighting scene association.

The generated light scene may be dynamic in that the lighting devices 140, 150, 160, 170, 180, 190 are controlled temporally or in sequence to provide a changing atmosphere in the environment 100.

Hence, the effect that each particular lighting device 140, 150, 160, 170, 180, 190 in the environment 100 is analyzed and a light scene generated that is both associated with and based on the keyword thereby enabling simple recall of personalized settings for the user environment, without requiring professional input.

In the above, methods and systems for generating and controlling a lighting scene of an environment are described. The environment has one or more controllable lighting devices. A keyword for a desired lighting scene for the environment is received, such as “nature”, and one or more images of the environment are provided in which at least one of the one or more lighting devices is controlled to provide an effect on the environment. An image source is explored, based on the keyword and images retrieved. The provided images are compared with the retrieved images to generate one or more lighting scenes and associated parameters of the one or more lighting devices, and the keyword associated with the one or more lighting scenes. The comparison may comprise one or more of color contrast, hue matching, pattern recognition to derive the lighting scenes and associated parameters to reproduce the lighting scene in the environment upon recall of the keyword.

It will be appreciated that the above embodiments have been described only by way of example. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for generating one or more lighting scenes of an environment having a plurality of controllable lighting devices, comprising:
receiving a keyword for a desired lighting scene for the environment,
providing a plurality of images of the environment, in each of which at least one of the plurality of lighting devices is controlled to provide different effects on the environment,
retrieving one or more images from an image source based on the keyword,
determining one or more lighting scenes for the environment by comparing the retrieved images with a linear combination of the provided images to generate one or more lighting scenes and associated parameters of the plurality of lighting devices, and associating the generated one or more lighting scenes and parameters with the keyword.

2. A method according to claim 1, wherein the determination of the one or more lighting scenes comprises correlating color values between the provided images of the environment and the retrieved one or more images.

3. A method according to claim 1, wherein the determination of the one or more lighting scenes comprises correlating color contrasts between the provided images of the environment and the retrieved one or more images.

4. A method according to claim 1, wherein the determination of the one or more lighting scenes comprises pattern recognition.

5. A method according to claim 1, wherein the one or more lighting scenes comprise a dynamic lighting scene.

6. A method according to claim 5, wherein the provided plurality of images are generated by controlling the plurality of lighting devices in sequence.

7. A method according to claim 6, wherein the plurality of lighting devices are cycled through their respective capabilities to provide the one or more images.

8. A method according to claim 6, wherein the generation of the provided plurality of images is generated automatically.

9. A method according to claim 1, wherein the image source is a public database.

10. A method according to claim 1, wherein the provided images comprise a user generated movie or sequence of images.

11. A method according to claim 1, wherein in each of said plurality of provided images the different effect comprises a different one of the plurality of lighting devices being controlled to be switched on while the others of the plurality of lighting devices are switched off.

12. A computer program product comprising computer executable code for performing the steps of claim 1 upon execution by a processor.

13. A system for generating a lighting scene of an environment, the system comprising:
an input interface for receiving a keyword for a desired lighting scene for the environment, and for receiving a plurality of provided images of the environment in each of which a plurality of lighting devices are controlled to provide different effects on the environment, and
an interface for communication with at least one processor, wherein the processor is arranged to:
retrieve one or more images from an image source based on the keyword,
determine one or more lighting scenes for the environment by comparing the retrieved images with a linear combination of the provided images to generate one or more lighting scenes and associated parameters of the plurality of lighting devices, and
associate the generated one or more lighting scenes and parameters with the keyword.

14. A system according to claim 13, wherein the interface includes a network interface for communication with a server and the image source.

15. A system according to claim 14, wherein the server is arranged to determine and generate the one or more lighting scenes and associated parameters of the plurality of lighting devices.
